(19) United States
(12) Patent Application Publication
(10) Pub. No.: US 2014/0200905 A1
(43) Pub. Date: Jul. 17, 2014

(54) Method and System for Template Proposals

(71) Applicant: Gary L. Gustafson, Laguna Niguel, CA (US)

(72) Inventor: Gary L. Gustafson, Laguna Niguel, CA (US)

(21) Appl. No.: 13/740,207

(22) Filed: Jan. 13, 2013

(51) Int. Cl. G06Q 50/22

(52) U.S. Cl. CPC G06Q 50/22
USPC 705/2

(57) ABSTRACT

A method and system comprise communicating with a host computer system via a network connection. The host computer system is configured to present a list of healthcare customers agreeing to receive a proposal for healthcare products or services, accept and review the proposal, and schedule an appointment with a vendor sending the proposal. The vender receives the list from the host computer system and communicates, to the host computer, a selection, from the list to purchase a template proposal for. The host computer system communicates the purchase to the selected healthcare customer. The vender receives the template proposal where the vender completes the template proposal and transfers the completed proposal to the healthcare customer for accepting and reviewing and scheduling of an appointment.

### CROSS-REFERENCE TO RELATED APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to sales proposals. More particularly, one or more embodiments of the invention relate to a customized template proposal system.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. It is believed that many medical manufacturers or suppliers may not be allowed to submit a proposal to certain healthcare facilities for a variety of reasons such as, but not limited to: the healthcare facility may have a non-committed contract with an existing competitor and because of that contract they don't actively seek a replacement product; the healthcare facility doesn't have an active program to pursue better or more cost effective products or services; the healthcare facility doesn't want to be bothered with taking the time or effort to seek new products or services; and the healthcare facility may not have a clear understanding of a current contract for a particular product or service. One may expect that this may make it difficult for healthcare suppliers to sell their products to these healthcare facilities.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, an aspect of the prior art generally useful to be aware of is that currently, there are available different types of electronic template proposals that can be populated by a supplier with template type answers or with answers customized for any potential customer. These systems apply to potential customers; thus, the proposals created may not be accurate for all customers that may respond to the proposal.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart illustrating an exemplary method for a customized template proposal system online to suppliers of healthcare products or services for guaranteed submittal authority and access to a customer, such as, but not limited to, a member hospital system or facility, in accordance with an embodiment of the present invention;

FIG. 2 is a flowchart illustrating an exemplary method for marketing a template proposal system to potential customers using Group Purchasing Organizations (GPOs), in accordance with an embodiment of the present invention;

FIG. 3 is a flowchart illustrating another exemplary method for a customized template proposal system, in accordance with an embodiment of the present invention;

FIG. 4 illustrates an exemplary customized template proposal system, in accordance with an embodiment of the present invention; and

FIG. 5 illustrates an exemplary computer system that, when appropriately configured or designed, can serve as an exemplary tracking system, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

An embodiment of the present invention provides a template proposal system customized to allow a vendor to demonstrate their true value to potential customers and to buy an opportunity for guaranteed acceptance of a proposal review and an eventual live presentation. Many practical embodiments may be able to benefit all parties as vendors may buy a guaranteed opportunity to submit a proposal that these vendors may not ordinarily be allowed to submit and the specified customers may have the opportunity to see and analyze new products that these customers may not ordinarily have the opportunity to see. Some embodiments may provide the potential to customers to obtain better quality and possibly better pricing of products and services.

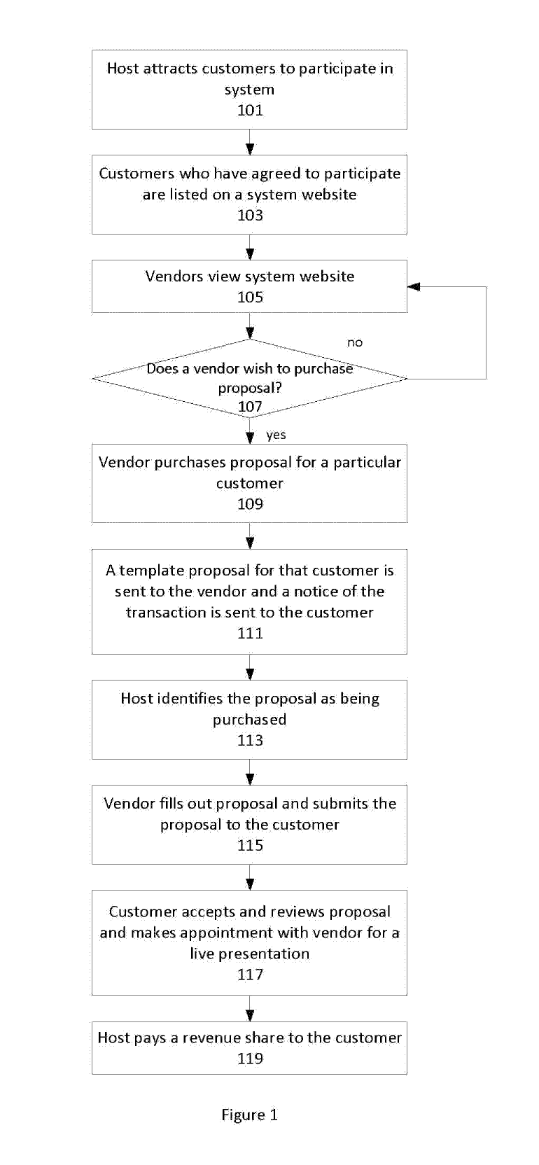

FIG. 1 is a flowchart illustrating an exemplary method for an online customized template proposal system for suppliers of healthcare products or services for guaranteed submittal authority and access to a customer, such as, but not limited to, a member hospital system or facility, in accordance with an embodiment of the present invention. In the present embodiment, the customer receives a revenue share from the system host on all purchases for proposals to that particular customer. Typically, at least three entities are involved in the system; a host, a customer, and a vendor. Multiple vendors and customers will most will likely be involved in systems according to the present embodiment. It is contemplated that various different types of entities may be involved in some embodiments such as, but not limited to, a Group Purchasing Organization (GPO), marketing entities, companies buying advertisement spots on the system, etc.

In the present embodiment, the host begins the process at step 101 by attracting customers such as, but not limited to, hospitals, hospital systems, clinics, laboratories, pharmacies, and other healthcare facilities that are willing to participate in the system at no charge. The host may use various different means to attract these customers such as, but not limited to, letters, advertisements, phone calls, email, by developing networking partners, etc. As customers agree to participate in the system, the host lists these customers on a system website in step 103. Customers who would like to be included in the system may opt into the program by filling out a participation form agreeing to receive and analyze proposals purchased by vendors and to schedule a session for the vendors to present their proposals in person. It is contemplated that various different types of agreements or terms of membership may be required to participate in the system in some alternate embodiments. In the present embodiment, prices for template proposals may be listed next to every customer on the website or may be available through an inquiry via phone, email, letter, etc. Vendors may view this website in step 105, and a vendor may decide if they wish to purchase a template proposal for any of the listed customers in step 107. If a vendor wishes to purchase a template proposal for a particular customer, the vendor may purchase this proposal in step 109. This purchase may be made through a store on the system website or through a phone call or email purchase. When the purchase is made, a template proposal for the customer chosen is automatically sent to the vendor with a notice that the transaction has been made going to the customer chosen in step 111. The host may optionally keep a record of the transaction. In step 113, the host may add an authorization number or other such indication to the template proposal which identifies the proposal as being paid for. In some embodiments this step may not be performed. In the present embodiment, once the vendor receives the template proposal, the vendor fills out the template proposal and submits the proposal to the customer of choice in step 115. The vendor may submit the proposal electronically or may send a physical proposal to the customer. In step 117, the customer accepts the proposal, reads the proposal, analyzes the proposal, and then makes an appointment with the vendor to enable the vendor to present the proposal in person. The system may have a predetermined time limit that the customer has agreed to in which the customer may respond to the proposal, for example, without limitation, within 30, 60 or 90 days of submittal of the proposal. If the customer does not respond in the agreed upon time frame, the issue is forwarded to the host, who will act as arbitrator.

The system includes, without limitation, a revenue share agreement between the customers and the host in which the host agrees to pay a revenue share to each customer based on the revenues generated by that particular customer. In step 119, the host pays the customer a share of the revenue collected by the proposal that was purchased. The frequency in which the host pays these revenue shares may vary depending on factors such as, but not limited to, the type of system or the type of customer. For example, without limitation, some systems may pay revenue shares on a quarterly basis, and other systems may pay per proposal. The rate of revenue share may vary from customer to customer for a variety of reasons including without limitation, how long the customer has participated in the system, the size of the customer's facility, the amount of revenue generated by the customer, whether the share is a flat fee or a percentage of the revenue, the number of template proposals on the website for that customer, etc. It is contemplated that some embodiments may be implemented without a revenue share arrangement.

A customized template proposal system according to the present embodiment typically guarantees that the proposal is purchased for a specific customer, which may enable the vendor to submit a more appropriate and specific proposal. This system also provides customers with a pre-approved standardized template proposal that generally ensures that vendors present the true value of their products and services. Customers may also have the opportunity to reduce healthcare costs and to explore different and alternate products and services which may enable the customers to improve healthcare in their facilities. This system also may offer a new revenue opportunity to customers in the form of the revenue share with the host. Furthermore, the vendor is normally guaranteed acceptance of their template proposal since customers who opt into this system have already agreed with the host to accept and analyze proposals and to offer at least one live meeting to the vendors to present these proposals.

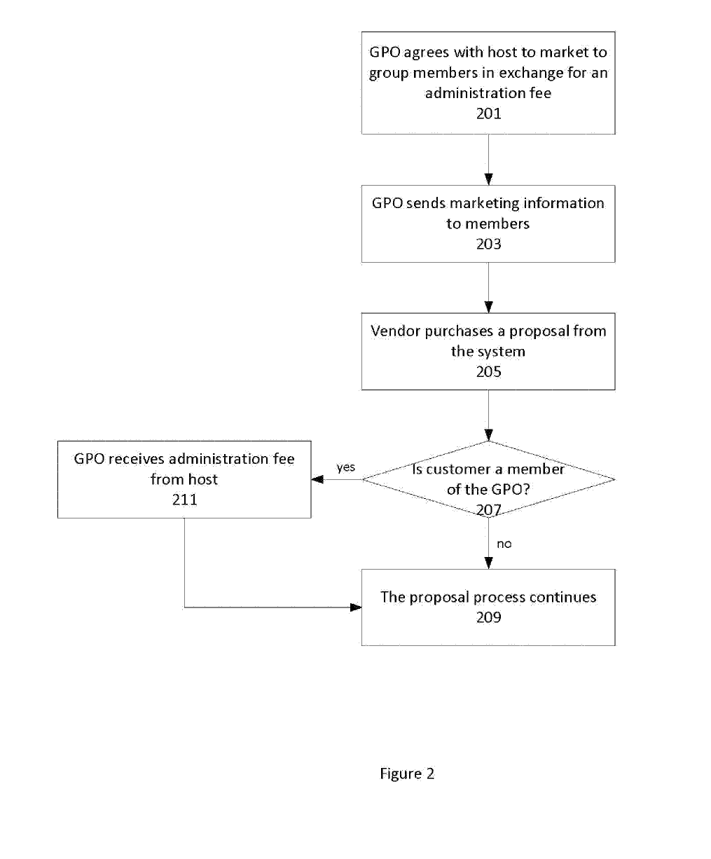

FIG. 2 is a flowchart illustrating an exemplary method for marketing a template proposal system to potential customers using Group Purchasing Organizations (GPOs), in accordance with an embodiment of the present invention. In general, healthcare GPOs have their own healthcare members to whom they may market. In the present embodiment, in step 201, a healthcare GPO may agree to provide marketing information to their members about participating in the template proposal system in exchange for an administration fee for all purchases on proposals to their GPO members. This fee may be for a percentage of the purchases made, for example, without limitation, 5% to 10% or may be a predetermined flat fee per purchase. In step 203, the GPO provides marketing information about the template proposal system to its members. Once a vendor purchases a proposal from the system in step 205, it is determined if the customer from which the proposal is purchased is a member of the GPO in step 207. If not, the proposal process continues as illustrated by way of example in FIG. 1. If the customer is a member of the GPO, the GPO receives an administration fee from the host in step 211, and then the proposal process continues. In addition to this marketing, the host may also perform his own marketing to vendors, customers and other GPOs through the website, newsletters, email, and other media. The host may also contact and work with multiple hospital systems directly to encourage multiple facilities to form one agreement with the host. In addition, the host may hire sales reps to sell the system vendors and/or customers.

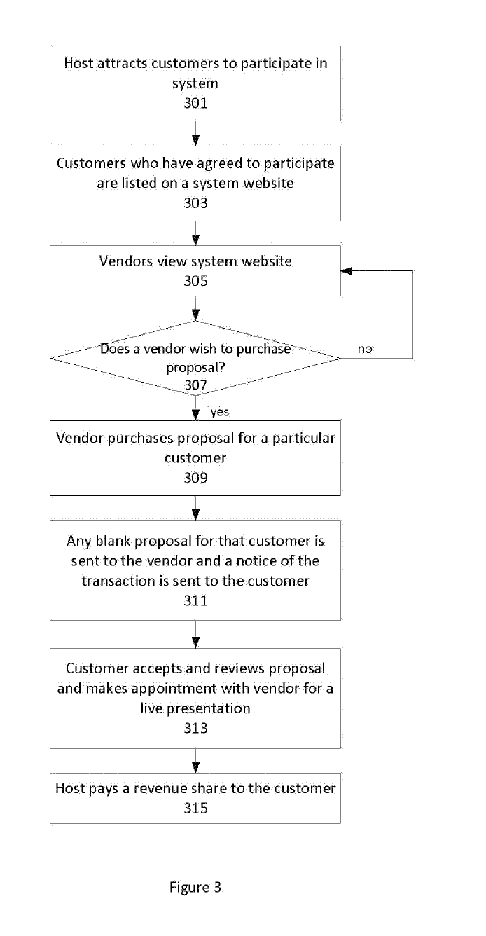

FIG. 3 is a flowchart illustrating another exemplary method for a customized template proposal system, in accordance with an embodiment of the present invention. In the preset embodiment, the host recruits customers to participate in the system in step 301 and lists these customers on a system website in step 303. The price for the proposal may be made available through the website or may be available for phone call orders. Vendors may then view the website in step 305 to decide whether to purchase any blank proposals from a customer in step 307. Blank proposals are template proposals that have not been completed. The same questions exist. When the purchasing vendor answers all the questions, it becomes a completed proposal. If the vendor chooses to do so, a purchase is made in step 309. Once the purchase is made, any blank proposal for the customer chosen is sent to the vendor, and a notice is sent to the customer that a transaction has been made in step 311. The vendor then completes the proposal and sends it to the custom. In step 313, the customer accepts and reviews the proposal and notifies the vendor if there is any interest in moving forward. In step 315, the host pays a revenue share back to the customer. In some embodiments the host may not pay a revenue share to customers.

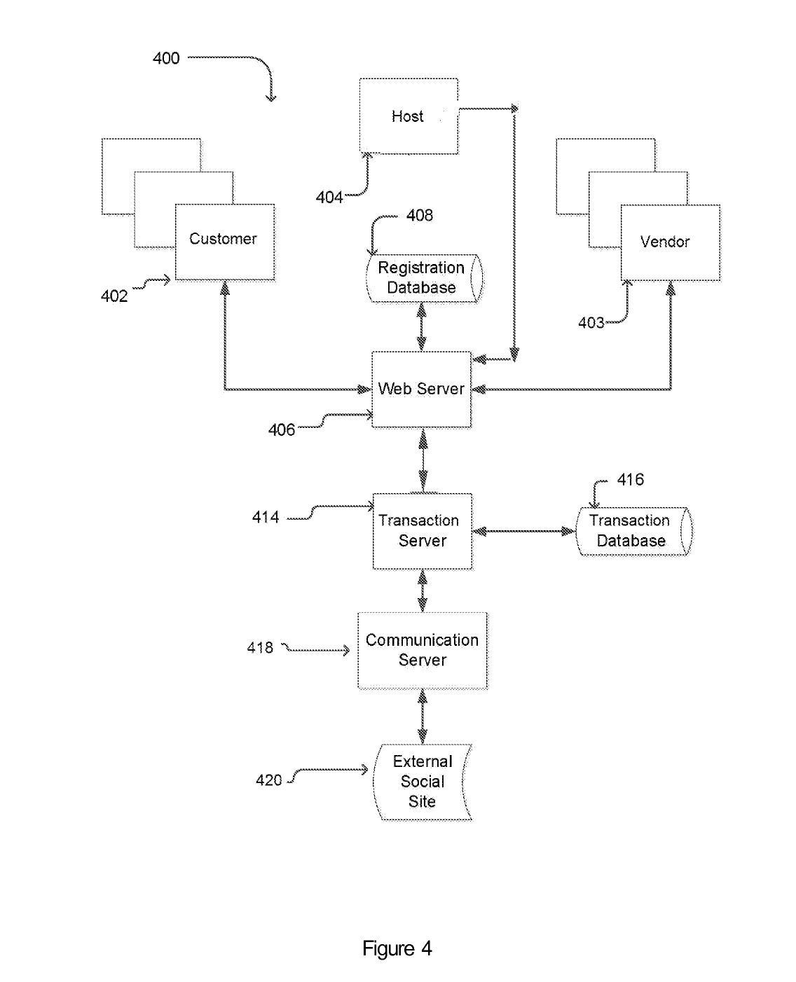

FIG. 4 illustrates an exemplary customized template proposal system, in accordance with an embodiment of the present invention. In template proposal system 400, a customer 402, a vendor 403, and a host 404 communicate together through a web server 406. In the present embodiment, the host 404 recruits customers 402 to participate in the template proposal system 400 and lists the customers 402 on a system website. Customer 402 and host 404 may register with template proposal system 400. Web server 406 may store price information for the proposals in registration database 408. Vendor 403 views price information in registration database 408 and decides whether to make purchase for customer 402. If a purchase is made, any blank proposal for the customer 402 is sent to the vendor 403, and a notice is sent to the customer 402 that a transaction has been made. Customer 402 and vendor 403 may transfer transaction information to web server 406. Transaction server 414 may format and store transferred transaction in transaction database 416. Communication server 418 may transfer price information to an external social site 420. Customer 402 accepts and reviews transaction and notifies the vendor 403 if there is any interest in moving forward.

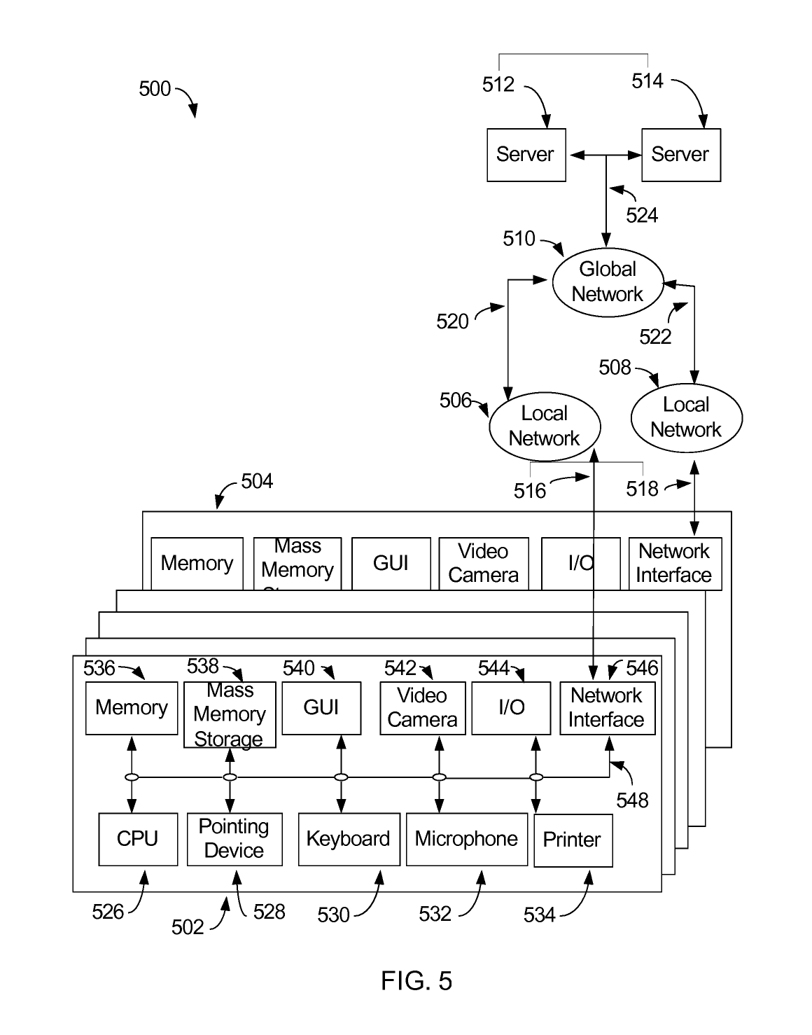

FIG. 5 illustrates an exemplary computer system that, when appropriately configured or designed, can serve as an exemplary tracking system, in accordance with an embodiment of the present invention. In the present invention, a communication system 500 includes a multiplicity of clients with a sampling of clients denoted as a client 502 and a client 504, a multiplicity of local networks with a sampling of networks denoted as a local network 506 and a local network 508, a global network 510 and a multiplicity of servers with a sampling of servers denoted as a server 512 and a server 514.

Client 502 may communicate bi-directionally with local network 506 via a communication channel 516. Client 504 may communicate bi-directionally with local network 508 via a communication channel 518. Local network 506 may communicate bi-directionally with global network 510 via a communication channel 520. Local network 508 may communicate bi-directionally with global network 510 via a communication channel 522. Global network 510 may communicate bi-directionally with server 512 and server 514 via a communication channel 524. Server 512 and server 514 may communicate bi-directionally with each other via communication channel 524. Furthermore, clients 502, 504, local networks 506, 508, global network 510 and servers 512, 514 may each communicate bi-directionally with each other.

In one embodiment, global network 510 may operate as the Internet. It will be understood by those skilled in the art that communication system 500 may take many different forms. Non-limiting examples of forms for communication system 500 include local area networks (LANs), wide area networks (WANs), wired telephone networks, wireless networks, or any other network supporting data communication between respective entities.

Clients 502 and 504 may take many different forms. Non-limiting examples of clients 502 and 504 include personal computers, personal digital assistants (PDAs), cellular phones and smartphones.

Client 502 includes a CPU 526, a pointing device 528, a keyboard 540, a microphone 542, a printer 544, a memory 546, a mass memory storage 548, a GUI 540, a video camera 542, an input/output interface 544 and a network interface 546.

CPU 526, pointing device 528, keyboard 540, microphone 542, printer 544, memory 546, mass memory storage 548, GUI 540, video camera 542, input/output interface 544 and network interface 546 may communicate in a unidirectional manner or a bi-directional manner with each other via a communication channel 548. Communication channel 548 may be configured as a single communication channel or a multiplicity of communication channels.

CPU 526 may be comprised of a single processor or multiple processors. CPU 526 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 546 is used typically to transfer data and instructions to CPU 526 in a bi-directional manner Memory 546, as discussed previously, may include any suitable computer-readable media, intended for data storage, such as those described above excluding any wired or wireless transmissions unless specifically noted. Mass memory storage 548 may also be coupled bi-directionally to CPU 526 and provides additional data storage capacity and may include any of the computer-readable media described above. Mass memory storage 548 may be used to store programs, data and the like and is typically a secondary storage medium such as a hard disk. It will be appreciated that the information retained within mass memory storage 548, may, in appropriate cases, be incorporated in standard fashion as part of memory 546 as virtual memory.

CPU 526 may be coupled to GUI 540. GUI 540 enables a user to view the operation of computer operating system and software. CPU 526 may be coupled to pointing device 528. Non-limiting examples of pointing device 528 include computer mouse, trackball and touchpad. Pointing device 528 enables a user with the capability to maneuver a computer cursor about the viewing area of GUI 540 and select areas or features in the viewing area of GUI 540. CPU 526 may be coupled to keyboard 540. Keyboard 540 enables a user with the capability to input alphanumeric textual information to CPU 526. CPU 526 may be coupled to microphone 542. Microphone 542 enables audio produced by a user to be recorded, processed and communicated by CPU 526. CPU 526 may be connected to printer 544. Printer 544 enables a user with the capability to print information to a sheet of paper. CPU 526 may be connected to video camera 542. Video camera 542 enables video produced or captured by user to be recorded, processed and communicated by CPU 526.

CPU 526 may also be coupled to input/output interface 544 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 526 optionally may be coupled to network interface 546 which enables communication with an external device such as a database or a computer or telecommunications or internet network using an external connection shown generally as communication channel 516, which may be implemented as a hardwired or wireless communications link using suitable conventional technologies. With such a connection, CPU 526 might receive information from the network, or might output information to a network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112(6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112(6).

It is noted that according to USA law, all claims must be set forth as a coherent, cooperating set of limitations that work in functional combination to achieve a useful result as a whole. Accordingly, for any claim having functional limitations interpreted under 35 USC §112(6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112(6) is/(are) dependent on one or more remote servers located outside the USA, it is intended that each such recited function under 35 USC §112(6) is to be interpreted as the function of the local system receiving the remotely generated information required by a locally implemented claim limitation, wherein the structures and or steps which enable, and breathe life into the expression of such functions claimed under 35 USC §112(6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112(6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing a template proposal system according to the present invention will be apparent to those skilled in the art. The invention has been described above by way of illustration, and the specific embodiments disclosed are not intended to limit the invention to the particular forms disclosed. For example, the particular implementation of the system may vary depending upon the particular type of businesses for which the system may be used. The systems described in the foregoing were directed to healthcare implementations; however, similar techniques are to provide template proposal systems for various different customers and industries such as, but not limited to, manufacturing, construction, virtually any type of service providing industry, etc. Non-healthcare implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method comprising the steps of:
communicating with a host computer system via a network connection, said host computer system being configured to present a list of healthcare customers agreeing to receive a proposal for healthcare products or services, accept and review said proposal, and schedule an appointment with a vendor sending said proposal;
receiving said list for display;
communicating, to said host computer, a selection, from said list, of a healthcare customer said vender has selected to purchase a template proposal for, said host computer system communicating said purchase to said selected healthcare customer; and
receiving, from said host computer system, said template proposal where said vender completes said template proposal and transfers said completed proposal to said healthcare customer for accepting and reviewing and scheduling of an appointment.

2. The method as recited in claim 1, in which a revenue sharing agreement with said healthcare customer, for the purchase of said template proposal, is administered by said host computer system.

3. The method as recited in claim 2, in which a share of said revenue from said purchase is transferred to said healthcare customer at predetermined time intervals.

4. The method as recited in claim 3, in which said predetermined time interval is a calendar quarter.

5. The method as recited in claim 1, in which said host computer identifies said template proposal as being purchased.

6. The method as recited in claim 5, in which said host computer identifies said template proposal by placing an indicia on said template proposal.

7. The method as recited in claim 1, in which said healthcare customer is a member of a group purchasing organization that has contracted to market said agreement to receive said proposal for healthcare products or services, accept and review said proposal, and schedule an appointment with said vendor sending said proposal.

8. The method as recited in claim 7, in which said host computer system administers payment to said group purchasing organization for revenues generated by said healthcare customer.

9. The method as recited in claim 1, in which said healthcare customer has further agreed to review said proposal, and schedule an appointment with said vendor within a predetermined period of time.

10. The method as recited in claim 1, in which said vender transfers said completed proposal to said healthcare customer electronically.

11. A method comprising:
steps for communicating with a host computer system via a network connection, said host computer system being configured to present a list of healthcare customers agreeing to receive a proposal for healthcare products or services, accept and review said proposal, and schedule an appointment with a vendor sending said proposal;
steps for receiving said list for display;
steps for communicating, to said host computer, a selection, from said list, of a healthcare customer said vender has selected to purchase a template proposal for, said host computer system communicating said purchase to said selected healthcare customer; and
steps for receiving, from said host computer system, said template proposal where said vender completes said template proposal and transfers said completed proposal to said healthcare customer for accepting and reviewing and scheduling of an appointment.

12. The method as recited in claim 11, in which: said vender transfers said completed proposal to said healthcare customer electronically; a revenue sharing agreement with said healthcare customer for the purchase of said template proposal is administered by said host computer system; a share of said revenue from said purchase is transferred to said healthcare customer at predetermined time intervals; said predetermined time interval is a calendar quarter; said host computer identifies said template proposal as being purchased by placing an indicia on said template proposal; said healthcare customer has further agreed to review said proposal, and schedule an appointment with said vendor within a predetermined period of time.

13. A system comprising:
at least one healthcare system for at least one healthcare customer agreeing to receive a proposal for healthcare products or services, accept and review said proposal, and schedule an appointment with a vendor sending said proposal, said healthcare system being configured for communicating via a network connection;
a host computer system being configured for communicating via a network connection, said host computer system further being configured to present a list comprising said at least one healthcare customer;
a vender client in communication with said host computer system, said vender client receiving said list for display and communicating a selection of said healthcare customer to purchase a template proposal for, said host computer system communicating said purchase to said selected healthcare customer and communicating to said vender client said template proposal where said vender completes said template proposal and transfers said completed proposal to said healthcare customer for accepting and reviewing and scheduling of an appointment.

14. The system as recited in claim 13, in which a revenue sharing agreement with said healthcare customer, for the purchase of said template proposal, is administered by said host computer system.

15. The system as recited in claim 14, in which a share of said revenue from said purchase is transferred to said healthcare customer at predetermined time intervals.

16. The system as recited in claim 15, in which said predetermined time interval is a calendar quarter.

17. The system as recited in claim 13, in which said host computer identifies said template proposal as being purchased.

18. The system as recited in claim 17, in which said host computer identifies said template proposal by placing an indicia on said template proposal.

19. The system as recited in claim 13, in which said healthcare customer has further agreed to review said proposal, and schedule an appointment with said vendor within a predetermined period of time.

20. The system as recited in claim 13, in which said vender transfers said completed proposal to said healthcare customer electronically.
